(19) United States
(12) Patent Application Publication
(10) Pub. No.: US 2015/0009680 A1
(43) Pub. Date: Jan. 8, 2015

(54) LENS AND LIGHT EMITTING ELEMENT USING THE SAME

(71) Applicant: ADVANCED OPTOELECTRONIC TECHNOLOGY, INC., Hsinchu Hsien (TW)

(72) Inventors: CHAO-HSIUNG CHANG, Hsinchu (TW); PIN-CHUAN CHEN, Hsinchu (TW); LUNG-HSIN CHEN, Hsinchu (TW); WEN-LIANG TSENG, Hsinchu (TW)

(21) Appl. No.: 14/321,765

(22) Filed: Jul. 1, 2014

(30) Foreign Application Priority Data
Jul. 4, 2013 (CN) 2013102786902

(51) Int. Cl. F21K 99/00; F21V 7/04; F21V 5/04

(52) U.S. Cl. CPC F21K 9/50; F21V 5/04; F21V 7/04; F21Y 2101/02
USPC 362/308; 362/327

(57) ABSTRACT

An exemplary lens includes a bottom surface, a first light exit surface extending upwardly from an outer periphery of the bottom surface, a second light exit surface extending upwardly from a top of the first light exit surface, and a reflecting surface extending inwardly and downwardly from a top of the second light exit surface towards the bottom surface to have a funnel-shaped configuration. A receiving space is defined in the bottom surface to receive a light source therein. The receiving space is defined by a top surface and a side surface interconnecting the top surface and the bottom surface. A pyramid surface is in the middle of the top surface and recessed upwardly and inwardly away from the bottom surface.

### BACKGROUND

1. Technical Field

This disclosure generally relates to light sources, and particularly to a lens and a light emitting element using the lens.

2. Description of Related Art

LEDs have many advantages, such as high luminosity, low operational voltage, low power consumption, compatibility with integrated circuits, faster switching, long term reliability, and environmental friendliness which have promoted their wide use as a light source.

A conventional LED generally generates a smooth round light field with a radiation angle of 114 degrees. The light emitted from the LED is mainly concentrated at a center thereof. The light at a periphery of the LED is relatively poor and cannot be used to illuminate. Therefore, light output efficiency of the conventional LED is decreased. Furthermore, when a plurality of the conventional LEDs is used as a light source in a direct-type backlight module, a plurality of round light fields is generated. Areas among the round light files are not illuminated and become dark, which causes the backlight module to have an uneven illumination to a display such as a liquid crystal display.

What is needed, therefore, is a lens and a light emitting element using the lens which can overcome the forgoing drawbacks.

### BRIEF DESCRIPTION OF THE DRAWINGS

FIG. 1 is a perspective view of a lens according to an embodiment of the present disclosure.

FIG. 2 is a cross-sectional view of the lens of FIG. 1, taken along line II-II thereof.

FIG. 3 is a cross-sectional view of a light emitting element applying the lens of FIG. 1

### DETAILED DESCRIPTION

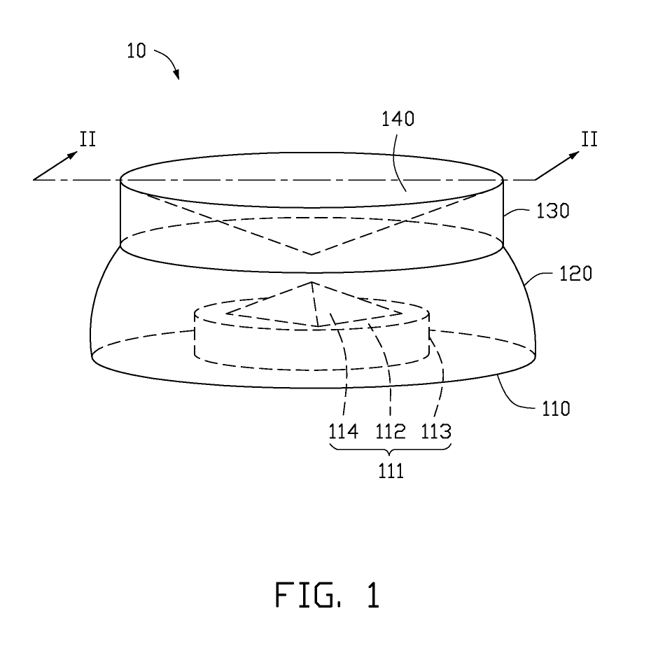

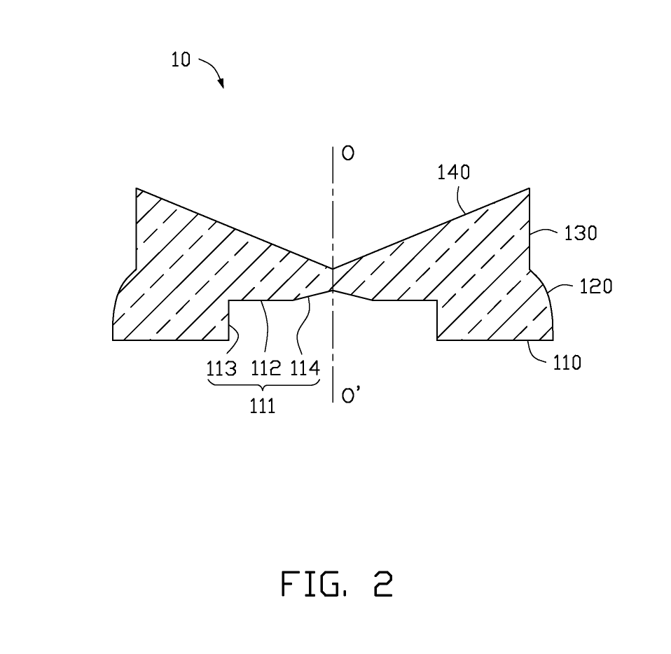

Referring to FIGS. 1-2, a lens 10 in accordance with an embodiment of the present disclosure is provided.

The lens 10 includes a bottom surface 110, a first light exit surface 120, a second light exit surface 130, and a reflecting surface 140. The first light exit surface 120 extends upwardly and inwardly from an outer periphery of the bottom surface 110. The second light exit surface 130 extends upwardly from a top of the first light exit surface 120. The reflecting surface 140 defines a funnel recessed downwardly from a top of the second light exit surface 130.

The lens 10 is made of polycarbonate, polymethyl methacrylate, or glass. In this embodiment, the lens 10 has an optical axis OO′, and the lens 10 is centrosymmetric with respect to the optical axis OO′.

The bottom surface 110 of the lens 10 is planar. A receiving space 111 is defined in a middle of the bottom surface 110 of the lens 10. The receiving space 111 is recessed upwardly from the middle of the bottom surface 110 of the lens 10, which is utilized to receive a light source, such as a light emitting diode. In this embodiment, the receiving space 111 is defined by a top surface 112 and a surrounding side surface 113 interconnecting the top surface 112 with the bottom surface 110 of the lens 10. Preferably, a pyramid surface 114 is located in a middle of the top surface 112, and recessed upwardly and inwardly therefrom. The optical axis OO′ extends through a tip of the pyramid surface 114. The side surface 113 is a cylindrical surface, and is perpendicular to the bottom surface 110 of the lens 10. The pyramid surface 114 is a quadrangular pyramid surface, and the vertex of the pyramid surface 114 is on the axis 00′.

The first light exit surface 120 extends upwardly and curvedly from the bottom surface 110 of the lens 10. In this embodiment, the first light exit surface 120 has an arc-shaped configuration which extends upwardly and inwardly toward the axis 00′, and an angle between the bottom surface 110 of the lens 10 and a tangential plane through any point in the first light exit surface 120 is less than 90 degrees. A distance between the first light exit surface 120 and the optical axis OO′ of the lens 10 gradually decreases along a bottom to top direction of the lens 10, whereby the first light exit surface 120 is a convex, arc-shaped surface.

The second light exit surface 130 extends upwardly from the top of the first light exit surface 120. In this embodiment, the second light exit surface 130 is a cylindrical surface and is perpendicular to the bottom surface 110 of the lens 10.

The reflecting surface 140 extends inwardly and downwardly towards the optical axis OO′ of the lens 10 from the top of the second light exit surface 130. That is, the reflecting surface 140 is recessed downwardly and inwardly towards the optical axis 00′ of the lens 10 to have a substantially funnel-shaped configuration. In this embodiment, the lowest point of the reflecting surface 140 is on the optical axis OO′ of the lens 10. And an angle defined by the reflecting surface 140 is less than or equal to 120 degrees to make almost all of light striking the reflecting surface 140 be reflected by the reflecting surface 140 toward the first light exit surface 120 and the second light exit surface 130.

A plane which extends through a junction between the first light exit surface 120 and the second light exit surface 130 is parallel to the bottom surface 110 of the lens 10, and the lowest point of the reflecting surface 140 is on the plane. Correspondingly, a distance between the vertex of the pyramid surface 114 and the bottom surface 110 of the lens 10 is less than a distance between the said plane defined by the junction between the first and second light exit surfaces 120, 130 and the bottom surface 110 of the lens 10.

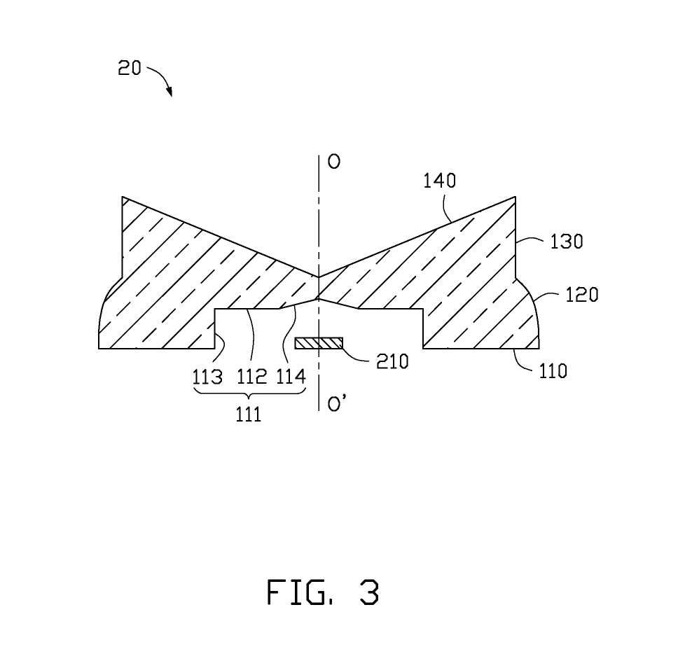

Referring to FIG. 3, a light emitting element 20 applying the lens 10 is provided. The light emitting element 20 includes the lens 10 of FIG. 1 and a light emitting diode 210. The light emitting diode 210 is located at the middle of the receiving space 111 defined in the bottom surface 110 of the lens 10. Light emitted from the light emitting diode 210 travels into the lens 10 from the top surface 112, the side surface 113 and the pyramid surface 114. A portion of the light striking the first light exit surface 120 and the second light exit surface 130 directly emits out of the lens 10 from the first light exit surface 120 and the second light exit surface 130. Another portion of the light directly strikes the reflecting surface 140, and is reflected by the reflecting surface 140 to emit out of the lens 10 via the first light exit surface 120 and the second light exit surface 130. In this embodiment, a center of the light emitting diode 210 is located on the optical axis OO′ of the lens 10.

According to the lens 10 and the light emitting element 20 applying the lens 10 of the disclosure, because the reflecting surface 140 extends inwardly and downwardly towards the optical axis OO′ of the lens 10, light striking the reflecting surface 140 is reflected by the reflecting surface 140 to emit out of the lens 10 via the first and second light exit surface 120, 130. The light leaves the lens 10 from the first and second light exit surfaces 120, 130 strike a board (not shown) on which the light emitting element 20 is mounted. A top surface of the board is coated with a light reflective material, whereby the light from the light emitting element 20 is reflected thereby to travel upwardly to illuminate a display (not shown), for example, an LCD (liquid crystal display).

That is, because of the reflecting surface 140, light emitting towards the optical axis OO′ of the lens 10 is decreased, and light emitting towards a direction away from the optical axis OO′ of the lens 10 is increased, such that, light emitting out of the lens 10 becomes more uniform, and the light emitting element 20 has a larger light distribution.

Furthermore, because the pyramid surface 114 is located in the middle of the top surface 112, and extends upwardly and inwardly towards the optical axis OO′, light striking the pyramid surface 114 is refracted towards a direction away from the optical axis OO′ of the lens 10, thereby the light emitting element 20 has a larger and square light field.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A lens configured for covering a light emitting diode, comprising:
a bottom surface, a receiving space being defined in the bottom surface and configured to receive the light emitting diode therein, the receiving space being defined by a top surface and a side surface interconnecting the top surface and the bottom surface, a pyramid surface being in the middle of the top surface and recessed upwardly and inwardly away from the bottom surface;
a first light exit surface extending upwardly an outer periphery of the bottom surface;
a second light exit surface extending upwardly from a top of the first light exit surface; and
a reflecting surface extending inwardly and downwardly from a top of the second light exit surface towards the bottom surface to have a funnel-shaped configuration.

2. The lens of claim 1, wherein the pyramid surface is a quadrangular pyramid surface.

3. The lens of claim 1, wherein a distance between a vertex of the pyramid surface and the bottom surface is less than a distance between the bottom surface and a plane defined by a junction of the first and second light exit surfaces.

4. The lens of claim 1, wherein a cross section of the first light exit surface has a arc-shaped configuration, and an angle defined by the bottom surface and a tangential plane through any point in the first light exit surface is less than 90 degrees.

5. The lens of claim 4, wherein the second light exit surface is a cylindrical surface, and is perpendicular to the bottom surface.

6. The lens of claim 1, wherein the side surface of the receiving space is a cylindrical surface.

7. The lens of claim 1, wherein a lowest point of the reflecting surface is on a plane defined by a junction between the first and second light exit surfaces.

8. The lens of claim 1, wherein the lens has an optical axis, and the lens is centrosymmetric with respect to the optical axis.

9. The lens of claim 8, wherein the pyramid surface is recessed upwardly and inwardly towards the optical axis.

10. The lens of claim 9, wherein the reflecting surface is recessed downwardly and inwardly from a top of the lens towards the optical axis.

11. A lens, comprising:
a bottom surface, a receiving space being defined in the bottom surface and configured to receive a light source therein, the receiving space being defined by a top surface and a side surface interconnecting the top surface and the bottom surface;
a first light exit surface extending upwardly from an outer periphery of the bottom surface;
a second light exit surface extending upwardly from a top of the first light exit surface; and
a reflecting surface extending inwardly and downwardly towards the bottom surface to have a funnel-shaped configuration.

12. The lens of claim 11 further comprising a quadrangular pyramid surface recessed upwardly and inwardly from the top surface defining the receiving space.

13. A light emitting element, comprising:
a lens; and
a light source received in the lens;
the lens comprising:
a bottom surface, a receiving space being defined in the bottom surface to receive the light source therein;
a pyramid surface being defined in the lens and located over the receiving space;
a first light exit surface extending upwardly from an outer periphery of the bottom surface;
a second light exit surface extending upwardly from a top of the first light exit surface; and
a reflecting surface extending inwardly and downwardly from a top of the second light exit surface towards the bottom surface to have a funnel-shaped configuration;
wherein a part of light from the light source striking the light reflecting surface via the pyramid surface is reflected by the reflecting surface to leave the lens via at least one of the first and second light exit surfaces.

14. The light emitting element of claim 13, wherein the lens is made of polycarbonate, polymethyl methacrylate, or glass.

15. The light emitting element of claim 13, wherein another part of the light from the light source directly leaves the lens from the first and second light exit surfaces.

16. The light emitting element of claim 15, wherein the light from the light source and out of the lens forms a square light field.

17. The light emitting element of claim 16, wherein the light source is a light emitting diode.
